(19) United States
(12) Patent Application Publication
(10) Pub. No.: US 2009/0115332 A1
(43) Pub. Date: May 7, 2009

(54) IMAGE DISPLAY DEVICE

(76) Inventors: Shin Imamura, Kokubunji (JP); Hitoshi Oaku, Tokyo (JP); Tatsuya Miyake, Tokorozawa (JP); Masaaki Komatsu, Kodaira (JP); Shunsuke Mori, Kokubunji (JP); Masatoshi Shiiki, Musashimurayama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/261,189

(22) Filed: Oct. 30, 2008

(30) Foreign Application Priority Data
Nov. 2, 2007 (JP) 2007-286045

(51) Int. Cl. H01J 17/49

(52) U.S. Cl. 313/582

(57) ABSTRACT

A problem of the present invention is to reduce discharge delay and discharge voltage in an image display device such as a PDP using ultraviolet rays emission generated by the discharge, thereby improving image quality and reducing cost. In order to solve the above problem, according to the present invention, the image display device using the ultraviolet rays emission generated by discharge includes, within a discharge space, a phosphor where a 1/10 afterglow time is 1 ms or more and a light emitting wavelength is in a range of 200 to 460 nm in which light emitting intensity is at the maximum. Under the same condition, the effect of the invention can be improved by making the 1/10 afterglow time 8 ms or more. Further, the effect of the present invention is further effective by making the 1/10 afterglow time 100 ms or more.

### CLAIM OF PRIORITY

The present application claims priority from Japanese Patent Application JP 2007-286045 filed on Nov. 2, 2007, the content of which is hereby incorporated by reference into this application.

### BACKGROUND OF THE INVENTION

The present invention relates to an image display device, and more particularly to an image display device, such as a plasma display panel, etc., configured to use a phosphor that is excited and light-emitted by ultraviolet rays, in particular, ultraviolet rays of a vacuum ultraviolet ray region.

In recent years, a demand for a display device used as television or a personal computer monitor without increasing a thickness and an installation space has been increased. As devices that can achieve thinness, a plasma display panel (PDP) device, a field emission display (FED) device, and a liquid crystal display (LCD) device that are configured by combining a backlight and a thin liquid crystal panel, and the like have been actively developed.

Among those, the PDP device is a display device that uses a plasma display panel (PDP) as a light emitting device. The plasma display panel (PDP) uses, as an excitation source, ultraviolet rays (when xenon is used as rare gas, the ultraviolet rays have a wavelength band of 146 nm and 172 nm) generated in a negative glow region of a micro discharge space including rare gas to excite phosphors in a phosphor layer that is disposed in the micro discharge space and obtains light emission in a visible region by inducing the light emission from the phosphor. The PDP device controls the amount and color of the light emission and uses them in the display.

The PDP device controls light emission and non-light emission by accumulating wall charges of a discharge cell at the time of displaying images of individual micro discharge spaces (hereinafter, referred to as the discharge cell). The wall charge controls the light emission and non-light emission by generating discharge, which is called address discharge prior to the light emission. Therefore, it is very important to accurately generate the address discharge in the image display. Further, power consumption of the PDP device can be increased and decreased depending on the discharge voltage at the time of generating the light emission. In addition, the discharge voltage is associated with the cost of a driving circuit. The discharge voltage is a very important factor in consideration of the performance of the PDP device.

In the PDP device, the phosphor determines characteristics of the amount and color of the light emission in the visible region, and the like. At the same time, the phosphor is installed within the discharge space, such that it also has an effect on the above-mentioned discharge characteristics. Therefore, materials of the phosphor are a very important factor in determining the characteristics of the PDP device. As documents describing these kind of materials and technologies, there are the following patent documents; JP-A-2003-142005, JP-A-Hei10(1998)-208647, and JP-A-2006-45449.

In recent years, since it has been recognized that the PDP device is excellent in view of performance, it replaces television (TV) or a monitor that is a type using a cathode ray tube and its usage is rapidly expanded to a large-sized flat panel display and a thin TV. As a result, there is a need to more improve the performance of the PDP device. In detail, in order to display Hi-Vision due to a digital broadcast, high resolution is needed. Further, in order to achieve the high resolution, high luminance is also needed since each of the display pixels is small and in order to achieve the high luminance, high luminous efficiency is also needed.

High resolution can be achieved, for example, by increasing the number of discharge cells. In the PDP device, in order to form one screen, light-emitted pixels are determined by scanning columns of pixels and generating the above-mentioned address discharge. Although one screen display is generally performed at 1/60 seconds, the PDP device further divides the screen into 10 or so and performs the display. Thus, the time required to generate the address discharge in each of the discharge cells is very short. In order to achieve the high resolution, since the columns of the pixels to be scanned are further increased, the time is further shortened. For this reason, when achieving the high resolution, it is difficult to accurately perform the address discharge.

Further, in a technical field of the PDP device, in order to achieve the high luminance by increasing the discharge intensity in each of the discharge cells, a method to improve a structure of the plasma display panel (PDP) as the high-performance TV device is now being reviewed.

As one method, a method of positively using two molecular beams generated by increasing a composition ratio of Xe gas in a discharge gas using Ne as the main component has been actively reviewed. Although a technology of ‘increasing concentration of xenon’ is a trend in the so-called PDP panel, a method of achieving high luminous efficiency of the plasma display panel in a region having a larger composition ratio than a general composition ratio (about 4%) of xenon gas in the discharge gas has been reviewed.

However, when the concentration of Xe is increased, the discharge voltage is often increased. This increases the load of the driving circuit and the cost of the device. Further, the increase in luminous efficiency is prevented.

Since the PDP device is a simple thin display device, its use as a flat TV device, which replaces the TV device using the cathode ray tube, has increased. As a result, the demand for high image quality has increased. Therefore, in order to meet the demands above, image quality should be improved by increasing the luminance or reducing a flicker of the screen, and the like. Further, power consumption and cost should be reduced.

For these reasons, in order to improve the image quality, it is important to shorten the time required to generate the address discharge and accurately generate the discharge. Further, in order to reduce power consumption and cost, it is important to reduce the discharge voltage.

The present invention proposes to solve the above problems. It is an object of the present invention to provide a high-image quality and high-efficiency image display device.

### SUMMARY OF THE INVENTION

Embodiments of the present invention disclosed in the present specification will be briefly described as follows.

The present invention can solve the above problems of an image display device by using ultraviolet rays emission generated by discharge, including, within a discharge space, a phosphor where a 1/10 afterglow time is 1 ms or more and a light emitting wavelength is in a range of 200 to 460 nm in which light emitting intensity is at the maximum.

Further, a preferably effective image display device uses ultraviolet rays emission generated by discharge, including, within a discharge space, a phosphor where a 1/10 afterglow time is 8 ms or more and a light emitting wavelength is in a range of 200 to 460 nm in which light emitting intensity is at the maximum.

In particular, an even more preferably effective image display device uses ultraviolet rays emission generated by discharge, including, within a discharge space, a phosphor where a 1/10 afterglow time is 100 ms or more and a light emitting wavelength is in a range of 200 to 460 nm in which light emitting intensity is at the maximum.

Moreover, as another configuration of the present invention, the above problems can be solved by an image display device using ultraviolet rays emission generated by discharge, including, when a maximum value of an interval from a discharge (sustain discharge) for performing a light emitting display in one discharge space to discharge (address discharge) for determining whether there is discharge in the discharge space or not is set to t, within the discharge space, a phosphor where a 1/10 afterglow time is t or more and a light emitting wavelength is in a range of 200 to 460 nm in which light emitting intensity is at the maximum.

When the image display devices are plasma display panel devices that include gas formed to include Xe gas whose composition ratio is 6% or more in discharge gas, the effect is more remarkable. Further, when the image display devices are the plasma display panel devices that are configured of more than 700 display pixel lines, the effect is more remarkable.

With the configuration of the present invention, since priming particles can be increased in the discharge space, the time required to generate the address discharge, that is, a delayed time can be shortened. Therefore, a multi gray scale display can be achieved and excellent images can be obtained.

### BRIEF DESCRIPTION OF THE DRAWINGS

FIG. 1 is a diagram showing characteristics of a delayed time in an image display device according to one embodiment of the present invention;

FIG. 2 is a diagram showing an example of light emitting spectral of a mixed phosphor applied to the embodiment of the present invention;

FIGS. 3A and 3B are diagrams showing characteristics of a discharge delayed time due to an afterglow time of the mixed phosphor of the present invention;

FIG. 4 is an exploded perspective view of main parts showing a structure of a plasma display panel, which is the image display device according to one embodiment of the present invention;

FIG. 5 is an exploded cross-sectional view of the main parts showing the structure of the plasma display panel, which is the image display device according to one embodiment of the present invention;

FIG. 6 is an exploded cross-sectional view of the main parts showing the structure of the plasma display panel, which is the image display device according to one embodiment of the present invention;

FIG. 7 is an exploded cross-sectional view of the main parts showing the structure of the plasma display panel, which is the image display device according to one embodiment of the present invention; and

FIG. 8 is a pattern diagram showing a change in time when voltage is applied to each of the electrodes of the plasma display panel, which is the image display device according to one embodiment of the present invention.

### DETAILED DESCRIPTION OF THE PREFERRED EMBODIMENTS

Hereinafter, representative examples of the embodiments of the present invention will be described and effects thereof will be described. The present invention can be applied to any configurations capable of achieving the same effects other than configurations as described below.

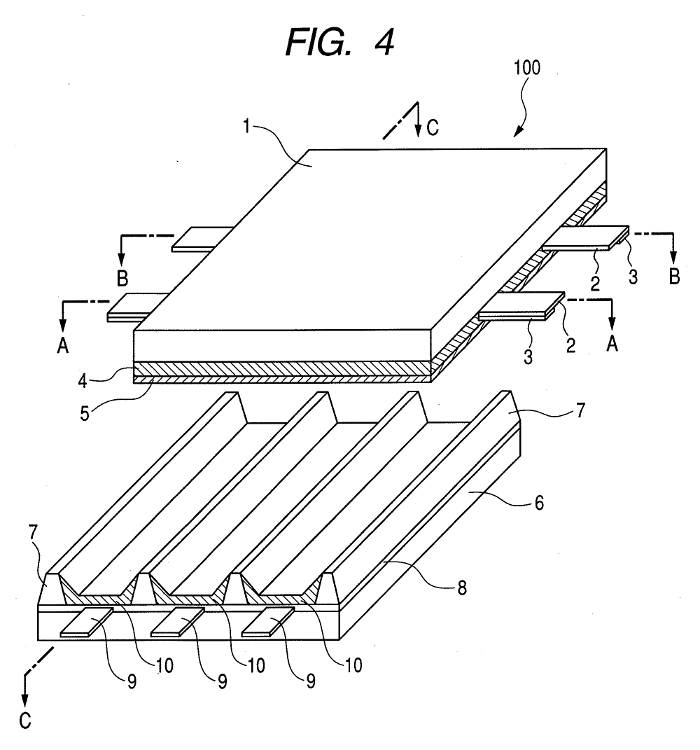

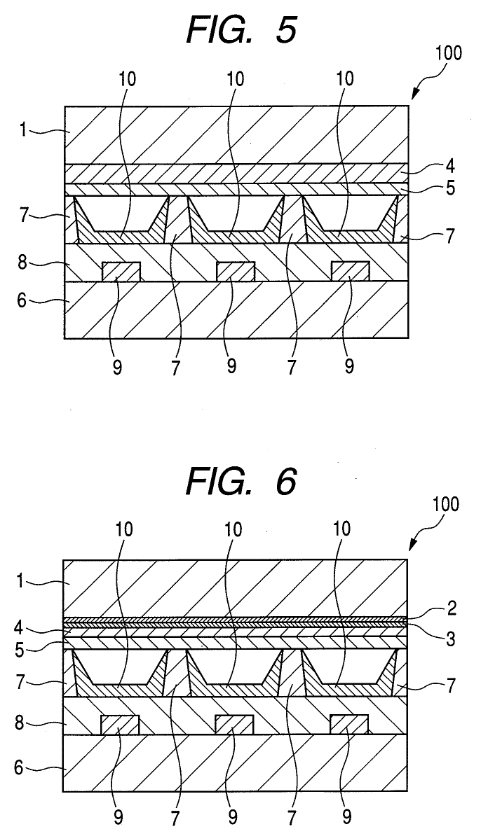

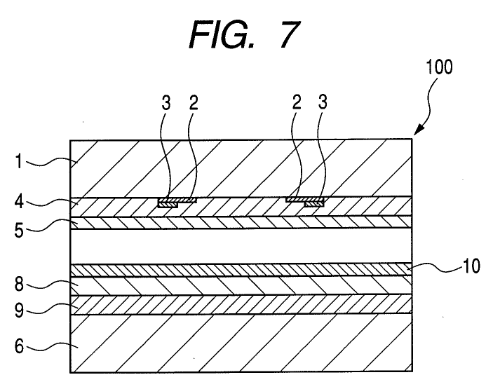

FIG. 4 is an exploded perspective view of the main parts showing a structure of a PDP according to one embodiment of the present invention. FIGS. 5 to 7 are cross-sectional views of the main parts showing a structure of a PDP according to one embodiment of the present invention. FIG. 5 is a cross-sectional view taken along the line A-A when a pair of substrates of FIG. 4 overlaps each other, FIG. 6 is a cross-sectional view taken along the line B-B, and FIG. 7 is a cross-sectional view taken along the line C-C.

A PDP 100 according to an embodiment of the present invention has a structure corresponding to a so-called surface discharge type PDP (reflective type alternating current driving). The PDP 100 includes a pair of substrates 1 and 6 that are arranged apart from each other and facing each other, a barrier rib 7 that is installed on the substrate 6 to maintain a gap between the substrate 1 and the substrate 6 when the pair of substrates 1 and 6 overlaps each other; a discharge gas (not shown) that is sealed in a space formed between the pair of substrates 1 and 6 to generate ultraviolet rays by discharge; and electrodes 2 and 9 that are installed on opposed surfaces of the pair of substrates 1 and 6. Further, FIG. 5 shows one cross section along an extending direction of the electrode 2, FIG. 6 shows another cross section along an extending direction of the electrode 2, and FIG. 7 shows one cross section along an extending direction of the electrode 9.

The phosphor used in a light emitting display forms a phosphor layer 10 on one 6 of the pair of substrates and on a surface of the barrier rib 7. The phosphor, which forms the phosphor layer 10, is excited by vacuum ultraviolet rays having a wavelength of 146 nm and 172 nm generated from the discharge gas by the discharge to light-emit visible light). Herein, the discharge space is a region that is surrounded by a dielectric 8, the barrier rib 7, and a protecting layer 5 in FIG. 4.

Further, a line shown as reference numeral 3 in FIGS. 4, 6 and 7 is a bus line 3 made of silver or Cu—Cr that is integrally installed with the electrode 2 to lower electric resistance, layers shown as reference numerals 4 and 8 are dielectric layers 4 and 8, and layer shown as reference numeral 5 is the protecting layer 5 that is disposed to protect the electrodes.

As an example shown in FIG. 4, although the barrier rib is a line shape, it can be permitted to have a rectangular structure that partitions each of the discharge cells.

The phosphor layer 10 is separately installed with three-color phosphors of red, green, and blue so as to perform a color display. As examples of phosphor that light-emits each color, there are (Y, Gd) BO₃:Eu phosphor as a red phosphor, a Zn₂SiO₄:Mn²⁺ phosphor as a green phosphor, and BAM (BaMgAl₁₀O₁₇:Eu²⁺) phosphor as a blue phosphor. Even though these phosphors as main components of each color are often used, they can be permitted to use other materials other than these materials. Although the phosphor having an average grain size of 1 to 5 μm is often used, it can be permitted to use the phosphor having a grain size other than the above-mentioned grain size.

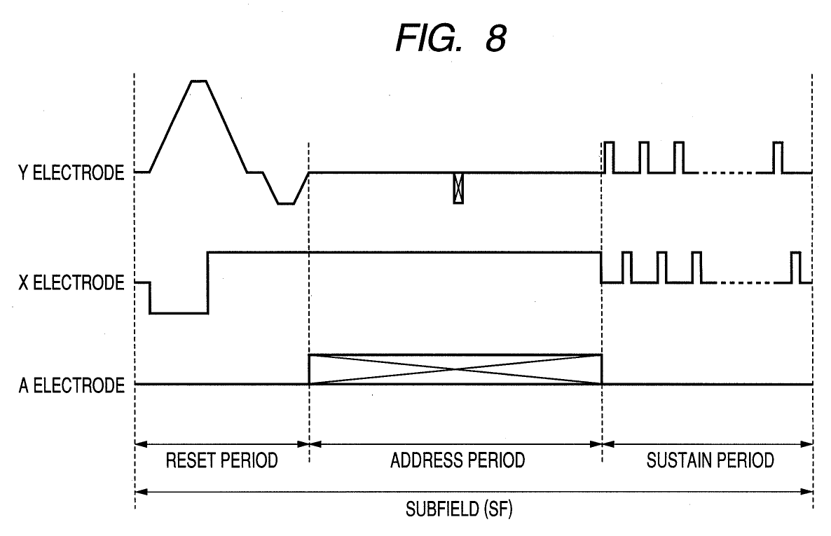

FIG. 8 shows an example of voltage applied to each electrode. A Y electrode and an X electrode are electrodes next to each other as shown in FIG. 4. The light emitting display is performed by the discharge voltage (sustain discharge) between two electrodes. The voltage for performing the sustain discharge is simultaneously applied to all of the discharge cells. For this reason, there is a need to select the discharge cells that generate the discharge and light emission and the discharge cells that does not perform the light emission. This is performed by generating the discharge between an A electrode and a Y electrode. The A electrode is the electrode 9 shown in FIG. 4.

When the discharge cells generating the light emission are selected, voltage is simultaneously applied to the A electrode and the Y electrode orthogonal to the A electrode. Only the discharge cells, which are simultaneously applied with voltage generate the discharge (address discharge) between the A electrode and the Y electrode. At this time, charges are accumulated in the discharge cells. Only voltage between the Y electrode and the X electrode cannot start the discharge because the voltage is set to voltage that cannot start the discharge. Therefore, the discharge starts only when the sum of the voltage between the X electrode and the Y electrode and the voltage generated by the accumulated charges are applied. For this reason, only the discharge cells, which generate the address discharge, generate the light emission by the discharge, making it possible to form images.

Further, since the discharge cells in which the wall charges are formed once, generate the sustain discharge at all times, there is a need to erase the wall charges so as not to generate the light emission. For this reason, before the voltage for generating the address discharge is applied, in all of the discharge cells, the voltage for erasing the wall charges is first applied. This voltage is a reset voltage and the time required to apply the reset voltage is a reset period.

A voltage application sequence shown in FIG. 8 depends on a period called a subfield. One image is formed for a period called one field. In order to make a difference in the luminance of each pixel forming one image, one field is divided into about 10 subfields and thus, successive discharges are performed in each of the subfields.

The address discharge is performed while scanning rows of pixels by one row. For this reason, if resolution is increased and the number of pixels is increased, the number of rows of pixels to be scanned is increased and the time required to generate one address discharge is reduced.

By applying voltage to the discharge cell, the discharge in the discharge cells starts by repeatedly performing a process that first moves a very small amount of charged particles existing in the discharge space due to electric field and collides the charged particles with the discharge gas to generate other charged particles. The charged particles, which are required to start the discharge and exist in the discharge space in a very small amount, are called the priming particles.

One of factors that determine the time required to generate the address discharge is the existing amount of the priming particles at the time of applying voltage. The discharge starts after the number of charged particles required to start the discharge after the voltage application is formed. The time required to start the discharge is called the discharge delayed time. If the priming particles are small, it correspondingly takes time to accumulate the number of charged particles required to start the discharge and thus, the discharge delayed time is long. In order to shorten the address discharge time, there is a need to shorten the discharge delayed time. Increasing the existing amount of priming particles is one method to shorten the discharge delayed time.

The priming particles are formed by the sustain discharge and the number of priming particles is reduced over time from the sustain discharge. For this reason, the time from after the sustain discharge ends to before the address discharge starts is important. As an example of this period, for a line that starts the scan of the rows of pixels for performing the address discharge, the period is about 0.2 ms, and for the last line, the period is about 1.2 ms.

One object of the configuration of the present invention shortens the time required to perform the address discharge in order to accurately perform the address discharge. By the configuration of the present invention, the existing amount of priming particles can be increased at the time of generating the address discharge such that the delayed time of the address discharge is shortened and the time required to generate the address discharge is shortened.

The priming particles are discharged from the protecting layer within the discharge cell, and the like. The discharge is often generated when energy is applied. As the energy, discharge, high-temperature heat energy, energy generated by irradiating light, and the like can be considered.

The inventors found that the delayed time of the address discharge can be shortened by irradiating light from a visible range to an ultraviolet range having a wavelength shorter than 460 nm. The light is effective when irradiation capacity is 0.1 μW/cm² or more. Further, the light is more effective when irradiation capacity is 1 μW/cm² or more. When the light is irradiated up to the start time of the address discharge after the sustain discharge ends, the reduction of the priming particles can be suppressed, but can be considered as one factor of shortening the delayed time.

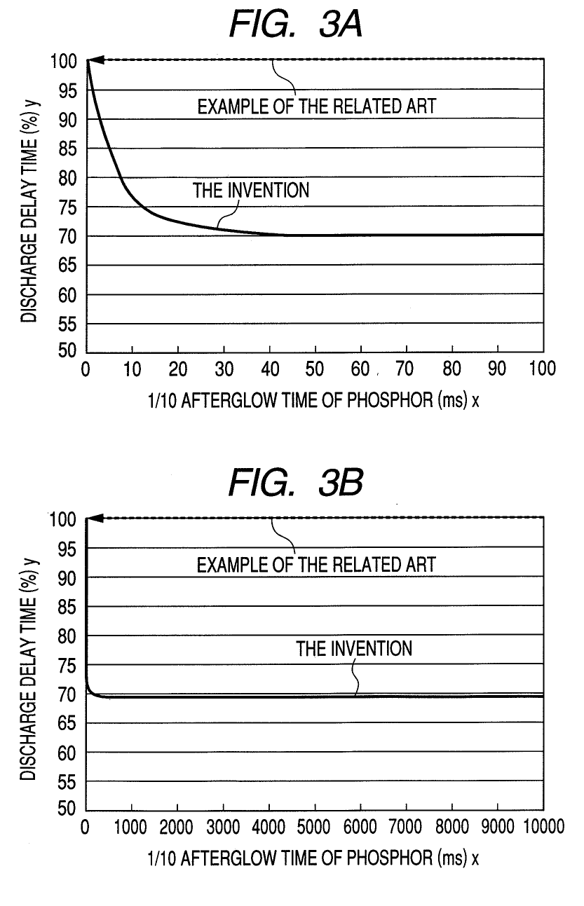

As one method of irradiating the light even when the sustain discharge ends, there is a method that installs phosphor (long afterglow phosphor) having long afterglow in the discharge cell and generates the light irradiation due to the afterglow even after the phosphor is excited by the sustain discharge. The phosphor is effective when making a maximum wavelength of the light emission to be 460 nm or less and the time ( 1/10 afterglow time) required to make the light emitting intensity 1/10 after the excitation ends is longer than the time t until the address discharge starts after the sustain discharge ends. For example, since the time t until the address discharge starts after the sustain discharge ends is typically 1 ms, when the time ( 1/10 afterglow time) required to make the light emitting intensity 1/10 after excitation ends is 1 ms or more, the phosphor is effective. This is a basic configuration of the present invention. Further, if the 1/10 afterglow time is 8 ms or more, the phosphor is more effective. This case is shown in FIG. 3A. In FIG. 3A, a horizontal axis x is the 1/10 afterglow time of the long afterglow phosphor that is installed within the discharge cell in the present invention. Herein, as one example of a method of installing the long afterglow phosphor within the cell, the results when a predetermined amount of the long afterglow phosphor is mixed in each of the red, green, and blue phosphors for the light emitting display are shown. In the embodiment shown in FIGS. 3A and 3B, the mixed amount of the long afterglow phosphor is 20 wt %. A vertical axis y of FIG. 3A is the discharge delayed time. When the discharge delayed time of the example of the related art is 100%, the change in the discharge delayed time of the embodiment is shown throughout the range until the 1/10 afterglow time is 100 ms. As shown in FIG. 3A, it can be appreciated that the discharge delayed time is shortened by making the 1/10 afterglow time 1 ms or more. Further, since the discharge delayed time is suddenly shortened until the 1/10 afterglow time is about 8 ms, the discharge delayed time can be remarkably shortened by making the 1/10 afterglow 8 m/s or more. As a result, it can be appreciated that the embodiment shown in FIG. 3A is more effective.

Further, the effect is more effective when the 1/10 afterglow time is 100 ms or more. If the afterglow time is the above-mentioned time or more, even when the time t until the address discharge starts after the sustain discharge ends elapses, the light emitting intensity of about 95% or more with respect to the light emitting intensity at the time of the excitation can be maintained. This is particularly effective for generating the priming particles. This case is shown in FIG. 3B. Although FIG. 3B is the same as FIG. 3A, it shows a wide range of the 1/10 afterglow time and the 1/10 afterglow time over a long time. When the discharge delayed time of the example of the related art is 100%, the change in the discharge delayed time of the embodiment is shown throughout the range until the 1/10 afterglow time is 10000 (10 s) ms. As shown in FIG. 3B, although the discharge delayed time is largely shortened up to 100 ms, the change in 100 ms or more is small. Herein, it can be appreciated that the discharge delayed time is 70% or less by making the 1/10 afterglow time 100 ms or more. In the specification of a Hi-Vision, the number of rows of pixels is increased and for each row, the time required to perform a scan for the address discharge is 70% or less of a general display. Therefore, if the discharge delayed time is 70% or less, the specification of the Hi-Vision can be displayed without changing the driving scheme. Further, even in the 1/10 afterglow time longer than 10000 ms, which exceeds the range shown in FIG. 3B, the discharge delayed time is shortened and the results without any noticeable changes can be obtained. For this reason, as the long afterglow phosphor used in the present invention, for example, the 1/10 afterglow time phosphor having a length of several minutes, several tens of minutes, or more can also obtain the above-mentioned effects.

Meanwhile, by controlling the afterglow time and the amount of the phosphor, after 1 ms from the stop of the phosphor excitation, when the light emitting intensity is 0.1 μW/cm² or more, improved effects are achieved. Further, after 8 ms from the stop of the phosphor excitation, when the light emitting intensity is 0.1 μW/cm² or more, improved effects are achieved. Further, as another factor, when light generated by the phosphor or light generated by light emitting the phosphor for the image display by the light is emitted outside the panel even after the sustain discharge ends, the degradation of contrast or the degradation of the image quality, such as an afterimage occurs. In order to solve the above problems, the above-mentioned degradation can be avoided by satisfying the following conditions.

In other words, the phosphor used in the PDP device is often controlled so that it is effectively light-emitted by exciting ultraviolet rays of 200 nm or less. For this reason, the wavelength that maximally generates the light emission of the long afterglow phosphor used in the configuration of the present invention is 200 nm or more, such that the light emission of the phosphor for the image display can be suppressed. It is more preferable that the wavelength that maximally generates the light emission is 300 nm or more.

Further, when the wavelength that maximally generates the light emission is 460 nm or less, since sensitivity of the human eye is low, if light emitted from the long afterglow phosphor used in the configuration of the present invention is reduced up to at least 200 μW/cm² or less after 8 ms from the stop of the phosphor excitation, the light emitted outside the panel is not revealed and thus, the effect on the image quality can be small. Further, if light emitted from the long afterglow phosphor is reduced up to at least 200 μW/cm² or less after 1 ms from the stop of the phosphor excitation, the effect on the image quality can be smaller.

The characteristics of the long afterglow phosphor used in the present invention are essentially preferable to continuously generate the light emission until the address discharge starts after the sustain discharge ends. Although the limitation of the above-mentioned afterglow time is based on the current sequence of the typical voltage application, there is a possibility to be changed later. More essentially, there is a method of further limiting the sustain discharge time and the address discharge time. The limitation method will be described below.

If the maximum value of an interval from the sustain discharge to the address discharge is t in one discharge space, the present invention includes, within the discharge space, the phosphor where the 1/10 afterglow time is t or more and the light emitting wavelength is in the range of 200 to 460 nm in which light emitting intensity is at the maximum, then the above configuration can be more effective.

Further, if the time displaying one image information piece is one field time, the present invention includes, within the discharge space, the phosphor where the 1/10 afterglow time is 1/16 field time or more and the light emitting wavelength is in the range of 200 to 460 nm, in which light emitting intensity is at the maximum, then the above configuration can be more effective. When one field is divided into 16, the time of each of the divided subfields is generally different. However, the discharge delay can be practically handled by making the 1/10 afterglow time one field/16.

The above-mentioned configuration of the present invention can make the light emission energy of the long afterglow phosphor used in the present invention 0.01% or more to 80% or less with respect to a total sum of the light emission energy of all of the phosphors existing within the discharge space. Further, the above-mentioned configuration of the present invention can make the weight of the long afterglow phosphor used in the present invention 0.01% or more to 80% or less with respect to a total sum of the weight of the entire phosphors existing within the discharge space.

Meanwhile, the above-mentioned configuration of the present invention can present the long afterglow phosphor used in the present invention in the phosphor layers for performing the light emitting display of visible light within the discharge space by the mixing or the multi layer. Further, the above-mentioned configuration of the present invention can dispose the long afterglow phosphor used in the present invention in the barrier rib and the front panel within the discharge space other than the phosphor layer for performing the light emitting display of visible light.

For the above-mentioned reason, when the present invention is used for the plasma display device including gas formed to include Xe gas whose composition ratio is 6% or more in the discharge gas, it is particularly effective. For the above-mentioned reason, when the present invention is used for the plasma display device configured of 700 display pixel lines or more, it is in particular effective.

Hereinafter, embodiments corresponding to the preferred embodiments according to the present invention will be described.

### FIRST EMBODIMENT

The PDP according to the embodiment of the present invention is manufactured. As the three-color phosphors of red, green, and blue, (Y, Gd) BO3:Eu phosphor as a red phosphor, a Zn₂SiO₄:Mn²⁺ phosphor as a green phosphor, and BAM (BaMgAl₁₀O₁₇:Eu²⁺) phosphor as a blue phosphor are used as the main components of each color. However, even though the present invention uses other phosphors as main components of each color other than the above-mentioned materials, the effect of the present invention is still effective.

The image display device of the present invention is manufactured by mixing, by a predetermined amount, phosphors where the 1/10 afterglow time is 1 ms or more and the light emitting wavelength is in the range of 200 to 460 nm in which light emitting intensity is at the maximum with each of the main phosphors of each color. An example of phosphors of satisfying the above-mentioned conditions may include CaAl₂O₄:Eu, Nd, Sr₃(La,Gd)₂Si₆O₁₈:Ce, YAl₃(BO₃)₄:Gd, Y(Al,Ga)₃O₅:Gd, Y₂SiO₅:Gd. Further, an example of satisfying the above-mentioned conditions may include a composition of BaSi₂O₅:Pb, YPO₄:Ce, LaPO₄:Ce, (Mg,Ba)Al₁₁O₁₉:Ce, SrB₄O₇:Eu, SrP₂O₇:Eu, Ca₂MgSi₂O₇:Ce, Y₂SiO₅:Ce, ZnSiO₄:Ti, and the like and the phosphors satisfying the characteristics can be used. The PDP 100, which is the image display device of the present invention shown in FIG. 4, is manufactured by mixing at least one of these phosphors in the range of 0.10 wt % to 80 wt %. When including the above-mentioned phosphors of 0.01%, the above-mentioned effect is achieved and when including the above-mentioned phosphors of 1% or more, the discharge start time can be shortened by about 5%. Meanwhile, when including the above-mentioned phosphors of 20% or more, it can be appreciated that the luminance of the PDP 100 is reduced. Therefore, it is preferable to include the above-mentioned phosphors of 1% to 20%. Although the phosphors are described above as an example, the mixed phosphors are not limited to the foregoing example, but any phosphors other than the above-mentioned phosphors can be used if they show the characteristics satisfying the conditions of the present invention.

FIG. 2 shows an example of the light emitting spectral of the phosphors satisfying the conditions of the present invention. In FIG. 2, the spectral A is YAl₃ (BO3) 4:Gd phosphor, the spectral B is BaSi₂O₅:Pb phosphor, and the spectral C is CaAl₂O₄:Eu, Nd phosphor.

In the PDP 100 of a surface discharge type color PDP device according to the first embodiment, for example, the discharge is generated by applying the negative voltage to one side (generally, called a scan electrode) of a pair of display electrodes (electrode 2) and positive voltage (positive voltage relative to the voltage applied to the display electrode) to the address electrode (electrode 9) and the other side of the remaining display electrode (electrode 2), such that the wall charges, which support to start the discharge between the pair of display electrodes, are formed (this is referred to as writing). In this state, when a proper reverse voltage is applied between the pair of display electrodes, the discharge is generated in the discharge space between both electrodes 2 via the dielectric layer 4 (and the protecting layer 5).

After the discharge ends, when the reverse voltage is applied to the pair of display electrodes (electrode 2), the discharge is newly generated. The discharge is continuously generated by repeating this (this is referred to as the sustain discharge or the display charge).

The PDP 100 according to the first embodiment forms the address electrode (electrode 9) made of silver and the like and the dielectric layer 4 made of a glass-based material on a rear substrate (substrate 6) and then, performs a thick film print on the barrier rib material made of the same glass-based material and removes a blast using a blast mask, thereby forming the barrier rib 7.

Next, each of the phosphor layers 10 of red, green, and blue is sequentially formed on the barrier rib 7 in a stripe shape such that it coats a groove surface between the corresponding barrier ribs 7.

Herein, each of the phosphor layers 10, which corresponds to red, green, and blue, is formed by making the red phosphor particles 40 parts by weight (making vehicle 60 parts by weight), the green phosphor particles 40 parts by weight (making vehicle 60 parts by weight), and the blue phosphor particles 35 parts by weight (making vehicle 65 parts by weight), making a phosphor paste by mixing each vehicle, applying it by a screen print, and then performing the evaporation of volatile components within the phosphor paste and the combustion removal of organic materials by drying and burning processes. Further, the phosphor layer 10 used in the embodiment is configured of each phosphor particle whose central grain size is about 3μm.

Next, the front substrate (substrate 1) on which the display electrode (electrode 2), the bus line 3, the dielectric layer 4, and the protecting layer 5 are formed and the rear substrate (substrate 6) are subjected to bullet sealing and are sealed by vacuum-exhausting the inside of the panel and injecting the discharge gas thereinto. The discharge gas is gas formed to include xenon (Xe) gas whose composition ratio is 10%. The size of PDP 100 according to the first embodiment is a 5 type.

Thereafter, a plasma display device, which is the image display device configured to perform the image display by using the PDP according to the embodiment of the present invention and combining the PDP and the driving circuit driving the PDP, is manufactured.

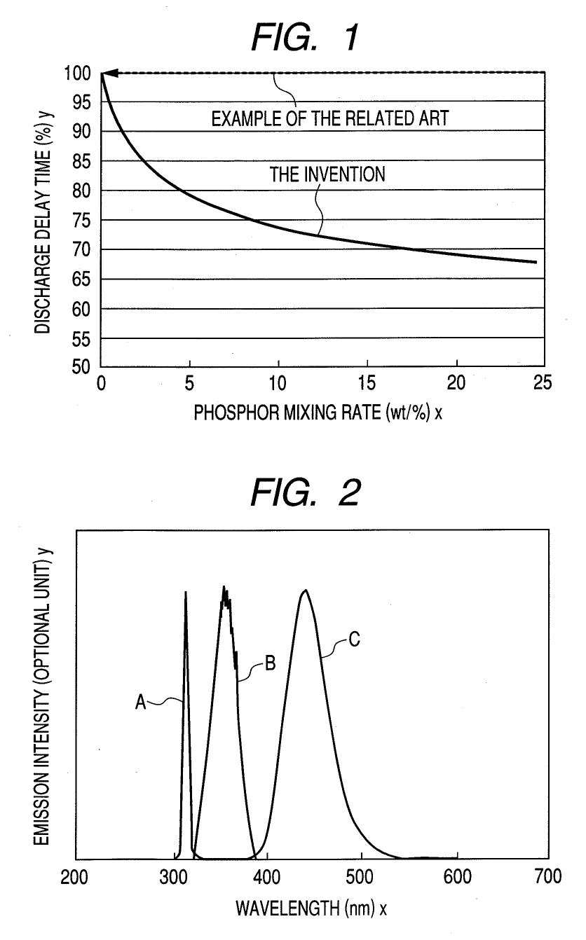

The plasma display device has excellent display performance due to high luminance, such that it can perform the display at high luminance. Also, the plasma display device can generate the high-speed address discharge while displaying high image quality on an image display with high resolution. FIG. 1 shows one example of the discharge delayed time of the image display device of the present invention and the dependency of the mixing amount of the phosphor satisfying the conditions of the present invention. In FIG. 1, a horizontal axis x is the mixed rate of the phosphor and a vertical axis y is the discharge delayed time. In FIG. 1, the mixed phosphor uses, in particular, the long afterglow phosphor and the 1/10 afterglow time is 1800 s or so. By the mixing, it can be appreciated that the discharge delayed time is shortened as compared to the related art.

Thereby, even in the image display device with 700 high-resolution pixel display lines or more, the degradation of the image quality, such as flicker, does not occur, such that the image display having the good image quality can be achieved.

Further, in the plasma display device, if Xe concentration is 6% or more, a trend to make the discharge delayed time long occurs. However, even if the Xe concentration is 6% or more, the degradation of the image quality, such as flicker, does not occur by using the present invention, such that the image display having high image quality can be achieved.

According to FIG. 1, the discharge delayed time can be shortened by about 5% by making the mixing amount 1 wt % or more. On the other hand, if the mixing amount is 80 wt %, since the light emitting intensity for performing the image display is reduced, high image quality cannot be obtained.

Further, in the light emitting intensity, the preferred condition is when the light emitting intensity is in the range of 0.1 μW/cm² to 200 μW/cm² after 1 ms from the stop of the excitation energy application for generating the light emission.

Further, FIGS. 3A and 3B show a change in the discharge delayed time by the 1/10 afterglow time of the mixed phosphors. FIG. 3A shows a range of the 1/10 afterglow time up to 100 ms and FIG. 3B shows a range of the 1/10 afterglow time up to 10000 ms.

In the embodiment shown in FIGS. 3A and 3B, the mixing amount of the phosphors is 20 wt %. In the case of the first embodiment, the maximum time t between the sustain discharge and the address discharge is about 1 ms. It can be appreciated from FIG. 3A that one having the 1/10 afterglow time longer than the maximum time t between the sustain discharge and the address discharge, that is, 1 ms can effectively shorten the discharge delayed time.

Further, if the time displaying one image information piece is one field, one field according to the first embodiment is 1/60 seconds and 1/16 field is about 1 ms. It can be appreciated from FIG. 3A that if the 1/10 afterglow time is 1/16 field time or more within the discharge time, that is, 1 ms or more, the discharge delayed time can be effectively shortened.

Moreover, even when the phosphors each having composition shown below is used as the red, green, and blue phosphors, the same PDP can be manufactured.

As the red phosphor, at least one phosphor of (Y,Gd)BO₃:Eu, (Y,Gd)₂O₃:Eu, and (Y,Gd) (P,V) O₄:Eu may be used. Further, as the green phosphor, at least one phosphor of YBO₃:Tb, (Y,Gd)BO₃:Tb, BaMgAl₁₄O₂₃:Mn, and BaAl₁₂O₁₉:Mn may be used. Moreover, as the blue phosphor, at least one phosphor selected from a group consisting of CaMgSi₂O₆:Eu, Ca₃MgSi₂O₈:Eu, Ba₂MgSi₂O₈:Eu, and Sr₃MgSi₂O₈:Eu may be used.

The above-mentioned phosphors are an example of the generally used phosphor and the effect of the present invention is effective regardless of the kind of used phosphors. Even when the phosphors other than the above-mentioned phosphors are used, it is possible to manufacture the image display device according to the present invention.

### SECOND EMBODIMENT

The PDP according to the second embodiment of the present invention is manufactured. The basic structure, phosphor material and manufacturing method of the second embodiment are the same as the first embodiment.

The difference with the first embodiment is that the image display device of the present invention is manufactured by directly applying a predetermined amount of phosphors to the side surface of the barrier rib 7 rather than mixing the phosphor where the 1/10 afterglow time is 1 ms or more and the light emitting wavelength is in the range of 200 to 460 nm in which light emitting intensity is at the maximum with the red, green, and blue phosphors for performing display. The image display device of the second embodiment shows good characteristics similar to the first embodiment.

### THIRD EMBODIMENT

The PDP according to the third embodiment of the present invention is manufactured. The basic structure, phosphor material and manufacturing method of the third embodiment are the same as the first embodiment.

The difference with the first embodiment is that the image display device of the present invention is manufactured by directly applying a predetermined amount of phosphors to one side of the substrate 1 and the portion of the protecting layer 5 rather than mixing the phosphor where the 1/10 afterglow time is 1 ms or more and the light emitting wavelength is in the range of 200 to 460 nm in which light emitting intensity is at the maximum with the red, green, and blue phosphors for performing the display. The image display device of the third embodiment shows good characteristics similar to the first embodiment.

As described above, although the present invention is described in detail on the basis of the aspects practicing the present invention and the embodiments configured by the inventors, the present invention is not limited thereto, but can be variously changed within the scope without departing from the subject of the present invention.

What is claimed is:

1. An image display device using ultraviolet rays emission generated by discharge, comprising, within a discharge space, a phosphor where a 1/10 afterglow time is 1 ms or more and a light emitting wavelength is in a range of 200 to 460 nm in which light emitting intensity is at the maximum.

2. An image display device using ultraviolet rays emission generated by discharge, comprising, within a discharge space, a phosphor where a 1/10 afterglow time is 8 ms or more and a light emitting wavelength is in a range of 200 to 460 nm in which light emitting intensity is at the maximum.

3. An image display device using ultraviolet rays emission generated by discharge, comprising, within a discharge space, a phosphor where a 1/10 afterglow time is 100 ms or more and a light emitting wavelength is in a range of 200 to 460 nm in which light emitting intensity is at the maximum.

4. The image display device using ultraviolet rays emission generated by discharge according to claim 1, comprising, within a discharge space, the phosphor where a light emitting wavelength is in a range of 200 to 460 nm in which light emitting intensity is at the maximum, wherein the light emitting intensity of the phosphor is 0.1 μW/cm² or more and 200 μW/cm² or less after 1 ms from the stop of excitation energy application for generating the light emission.

5. The image display device using ultraviolet rays emission generated by discharge according to claim 1, comprising, within a discharge space, the phosphor where a light emitting wavelength is in a range of 200 to 460 nm in which light emitting intensity is at the maximum,
wherein the light emitting intensity of the phosphor is 1 μW/cm² or more and 200 μW/cm² or less after 1 ms from the stop of excitation energy application for generating the light emission.

6. The image display device using ultraviolet rays emission generated by discharge according to claim 1, comprising, within a discharge space, the phosphor where a light emitting wavelength is in a range of 200 to 460 nm in which light emitting intensity is at the maximum,
wherein the light emitting intensity of the phosphor is 0.1 μW/cm² or more and 200 μW/cm² or less after 8 ms from the stop of excitation energy application for generating the light emission.

7. An image display device using ultraviolet rays emission generated by discharge, comprising, when a maximum value of an interval from discharge for performing a light emitting display in one discharge space to discharge for determining whether there is discharge in the discharge space or not is set to t, within a discharge space, a phosphor where a 1/10 afterglow time is t or more and a light emitting wavelength is in a range of 200 to 460 nm in which light emitting intensity is at the maximum.

8. An image display device using ultraviolet rays emission generated by discharge, comprising, when time displaying one image information piece is one field time, within a discharge space, a phosphor where a 1/10 afterglow time is 1/16 field time or more and a light emitting wavelength is in a range of 200 to 460 nm in which light emitting intensity is at the maximum.

9. The image display device according to claim 1, wherein the light emitting energy of the phosphor is 0.01% or more and 80% or less with respect to a total sum of the light emission energy of all the phosphors existing within the discharge space.

10. The image display device according to claim 1, wherein the weight of the phosphor existing within the discharge space light is 0.01% or more and 80% or less with respect to a total sum of the weight of all the phosphors existing within the discharge space.

11. The image display device according to claim 1, wherein the weight of the phosphor existing within the discharge space light is 1% or more and 20% or less with respect to a total sum of the weight of all the phosphors existing within the discharge space.

12. The image display device according to claim 1, wherein the phosphor exists in a layer of the phosphor for performing the light emitting display of visible light within the discharge space.

13. The image display device according to claim 1, wherein the phosphor is installed in a barrier rib and a front panel other than the layer of the phosphor for performing the light emitting display of visible light within the discharge space.

14. The image display device according to claim 1, wherein the image display device is a plasma display panel device that includes gas formed to include Xe gas whose composition ratio is 6% or more in discharge gas.

15. The image display device according to claim 1, wherein the image display device is a plasma display device configured of 700 display pixel lines or more.
